(19) United States
(12) Patent Application Publication
(10) Pub. No.: US 2012/0250010 A1
(43) Pub. Date: Oct. 4, 2012

(54) Aerial Inspection System(s) and Method(s)

(76) Inventor: Richard Charles Hannay, Conroe, TX (US)

(21) Appl. No.: 13/436,226

(22) Filed: Mar. 30, 2012

Related U.S. Application Data
(60) Provisional application No. 61/470,252, filed on Mar. 31, 2011.

(51) Int. Cl. G01N 21/88

(52) U.S. Cl. 356/237.1

(57) ABSTRACT

An aerial inspection system has at least one transmission line, an aerial vehicle, and a detection device coupled to the aerial vehicle. The detection device is configured to detect a condition of the transmission line as the aerial vehicle flies across the transmission line. The aerial vehicle may be in the form of a drone.

### CROSS-REFERENCE TO RELATED APPLICATIONS

This application claims the benefit of U.S. Provisional Application No. 61/470,252 filed Mar. 31, 2011.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Transmission lines may be used to transmit power, energy, and/or data to and from various locations. The transmission lines for example may be electric lines, fiber optic cables, wirelines, pipelines and the like. The transmission lines may be located in cities and towns and/or be located in remote areas. The transmission lines may become damaged during installation, maintenance, and/or due to wear and tear. Damaged transmission lines may reduce the efficiency and/or effectiveness of the transmission lines. To inspect transmission lines for damage, a line man may have to travel the length of the transmission line on foot, or by ground transport, to check for the damage. In remote locations it may be impossible, or difficult, to inspect the transmission lines. There is a need to provide a quicker and more economical method for inspecting the transmission line.

### BRIEF SUMMARY

An aerial inspection system has at least one transmission line, an aerial vehicle, and a detection device coupled to the aerial vehicle. The detection device is configured to detect a condition of the transmission line as the aerial vehicle flies across the transmission line. The aerial vehicle may be in the form of a drone.

As used herein the term “across” shall refer to and include over, under, alongside and transverse.

### BRIEF DESCRIPTION OF THE DRAWINGS

FIG. 1 depicts a schematic view of one embodiment of an aerial inspection system.

FIG. 2 depicts a schematic view of a portion of one embodiment of the aerial inspection system.

### DETAILED DESCRIPTION OF THE EMBODIMENTS

The present embodiments may be better understood, and numerous objects, features, and advantages made apparent to those skilled in the art by referencing the accompanying drawings. These drawings are used to illustrate only typical embodiments of this invention, and are not to be considered limiting of its scope, as the invention may admit to other equally effective embodiments. The figures are not necessarily to scale and certain features and certain views of the figures may be shown exaggerated in scale or in schematic in the interest of clarity and conciseness.

Embodiments may include the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on an on-board and/or user's computer, partly on the on-board and/or user's computer, as a stand-alone software package, partly on an on-board and/or user's computer and partly on a remote computer or entirely on the remote computer or server. In the latter scenario, the remote computer may be connected to the on-board and/or user's computer through any type of network, including a local area network (LAN), a personal area network (PAN), or a wide area network (WAN), or the connection may be made to an external computer (for example, through the Internet using an Internet Service Provider).

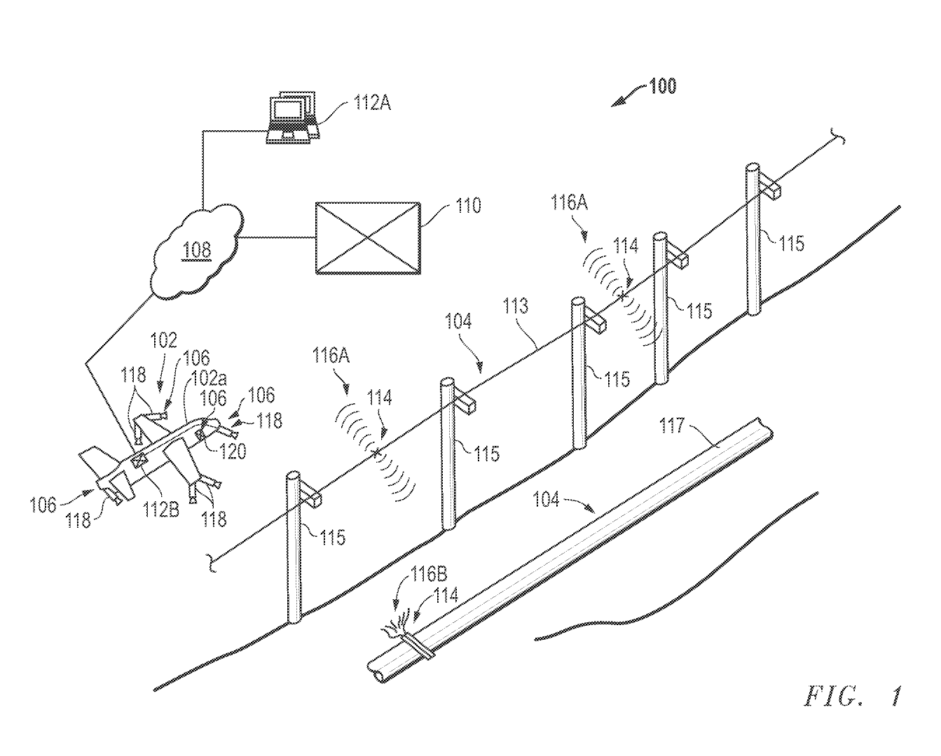

FIG. 1 depicts a schematic view of an aerial inspection system 100 according to an embodiment. The aerial inspection system 100 may have an aerial vehicle 102 for monitoring one or more transmission line(s) 104. Further, the aerial inspection system 100 may have one or more detection devices 106, a communication network 108 (by way of example only which may incorporate a global positioning satellite or other satellite based network; and/or a land based network optionally including cell phone tower or networking system), a controller 110, and/or one or more client computers 112 (112A and 112B shown) (and/or a processor with a data recording device). The aerial inspection system 100 may allow the aerial vehicle 102 to fly across (typically but not limited to over), and generally along and parallel to the one or more transmission lines 104 while the one or more detection devices 106 detect a condition of the transmission lines 104. The aerial vehicle 102 may be controlled by the controller 110 remotely. The data collected by the one or more detection devices 106 may be sent to the one or more client computers 112 (112A and 112B shown) (and/or an owner of the one or more transmission lines) for collection, storage, analysis, action plans, reports, and the like. The aerial inspection system 100 may employ more than one, and may employ many, aerial vehicles 102.

The aerial vehicle 102 as shown is an unmanned plane. Although the aerial vehicle 102 is shown in the currently preferred embodiment as the unmanned plane in the nature of a drone 102a, it should be appreciated that the aerial vehicle 102 may be any suitable aerial vehicle including a helicopter, a plane, a drone, a glider, and the like. The aerial vehicle 102 may be remotely controlled by the controller 110, or be flown by a pilot (not shown). The aerial vehicle 102 may have any suitable power source including, but not limited to, an electric motor, a combustion engine, a jet engine, any combination thereof and the like. The electric motor may be powered by batteries and/or any suitable alternative power source, or charging source.

The one or more transmission lines 104 may be any suitable delivery device for data, power, liquids, energy, and the like. FIG. 1 shows the transmission lines 104 as an electric transmission line 113 on a plurality of pole supports 115 and a pipeline 117 running along the ground. Although the one or more transmission lines 104 are shown as the electric transmission line 113 and the pipeline 117 it should be appreciated that the one or more transmission lines 104 may include, but is not limited to, one or more power lines, utility lines, fiber optic cables, pipelines, a static wire, phase A transmission lines, phase B transmission lines, phase C transmission lines, multi-grounded neutral lines, communication lines, and/or the like.

The one or more transmission lines 104 may have any number of infrastructure and/or support pieces, such as the plurality of pole supports 115, shown in FIG. 1, for accommodating the support of the one or more transmission lines 104. The infrastructure may include, but is not limited to, support poles, towers, lattice towers, structure arms, hardware, poles, ground wires, insulators, bolts, transformers, pipe racks, pipe bridges, pipe sleepers, pumping stations, and the like. Over the lifetime of the one or more transmission lines 104 one or more conditions 114 of the transmission line 104 may need to be detected. The aerial inspection system 100 may inspect and report on the any of the conditions 114 that arise along the transmission lines 104.

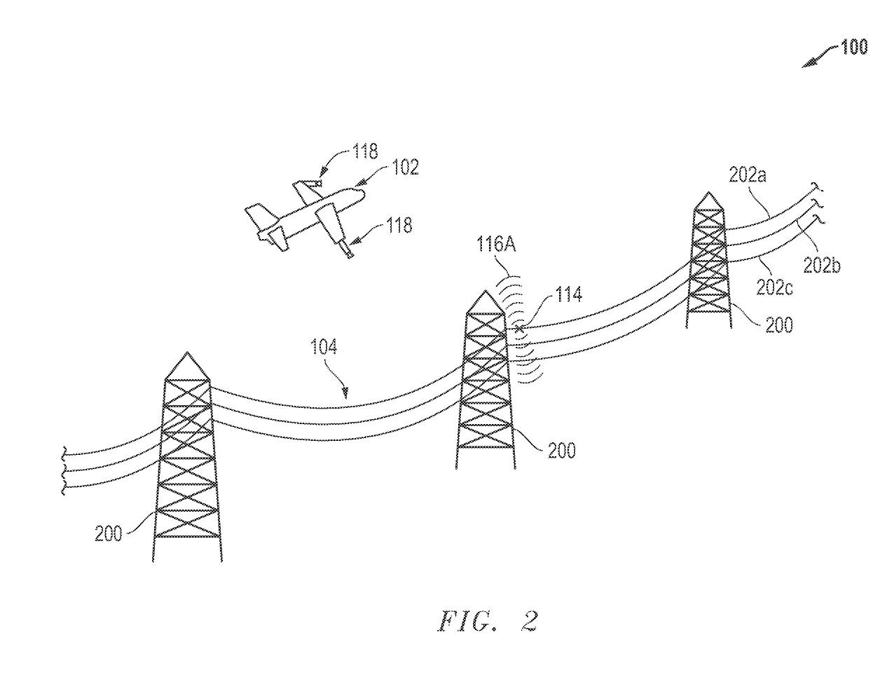

FIG. 2 depicts the infrastructure as a plurality of towers 200 for supporting the one or more transmission lines 104. As shown by way of example only, the one or more transmission lines 104 are a phase A transmission line 202a, a phase B transmission line 202b, and a phase C transmission line 202c. It should be appreciated that there may be any other suitable transmission lines 104 coupled to the plurality of towers 200 including, but not limited to, those described herein.

The condition 114 may be any condition including, but not limited to damage or a defect, tampering, theft, a maintenance item, and the like. The damage or defect for example may include, but is not limited to, broken insulators, loose bolts, loose or missing ground wires, an exposed line, a leaking pipe, a leaking pipe flange, broken equipment, and the like. The condition 114 may be inspected visually. Further, the condition 114 may give off a signal 116A, a fluid 116B, a waveform, a sound, and the like. The condition 114 given off may be detectable by the one or more detection devices 106.

The one or more detection devices 106 may be any suitable detection devices and/or systems. The one or more detection devices 106 may have one or more cameras 118 and one or more receivers, sensors and/or sensor arrangements 120. The one or more detection devices 106 may be located at any suitable location about the aerial vehicle 102 including, but not limited to, the nose, the fuselage, the wings, the tail and the like. The one or more cameras 118 may be any suitable cameras for visually imaging the one or more transmission lines 104 and/or the infrastructure. The one or more cameras 118 may be controllable to adjust focus, and/or the direction that is filmed. The controllable camera may allow the aerial detection system 100 to film the one or more transmission lines 104 while the location of the aerial vehicle 102 changes. The one or more cameras 118 may be any suitable camera including, but not limited to, a video camera, a digital camera, high resolution cameras, and the like. Cameras 118 located on the ends of both of the wings (as shown in FIG. 2) may allow the cameras 118 to film, or image, both sides of the transmission lines 104 and/or the infrastructure. Three or more cameras 118 may be mounted and incorporated for purposes of producing three-dimensional images. Several sensors may be integrated into a sensor arrangement for producing greater accuracy or efficiency in readings.

The one or more receivers 120 may be any suitable detection device for detecting any suitable signal and/or waveform emitted from the one or more transmission lines 104. For example, the receivers 120 may detect any suitable signal including, but not limited to, audio, radiation, microwaves, light, and the like.

The one or more detection devices 106 may then send the data collected to the client computer 112A, and/or a computer 112B on-board the aerial vehicle 102. The computers 112A and/or 112B may collect, analyze, manipulate, process, and report on the data collected by the one or more detection devices 106 using, for example, software, algorithms, etc. One or more reports may be created by the computers 112A and/or 112B for delivery to a client and/or worker. In another embodiment for conservation of energy, the one or more detection devices 106 may collect data to the computer 112B on-board the aerial vehicle 102 only for recording data (and optionally analyzing) on-board only. The computer 112B may collect, analyze, manipulate, process, and report on the data collected by the one or more detection devices 106 after the aerial vehicle 102 returns to a homebase or only report to the network 108 when certain programmed conditions are met. The reports may indicate where damage on the transmission line 104 is inferred or located. Further, the reports may indicate where there may be potential for damage in the future. The reports may then be given to a client and/or a worker (not shown). The client and/or worker may take the reports to determine the best course of action for repairing the damage and/or remediating the damage. The reports may be in any suitable form including, but not limited to, video form, a DVD of the transmission line flight, picture form, map form, written reports, and the like. The aerial vehicle 102 may be recharged or refueled at a home-base, by placement or mounting within proximity of the transmission lines 104 (by way of example by coupling or docking on a tower 220), and/or by integrating solar panels into the external structure of the aerial vehicle 102.

In one example, the aerial vehicle 102 may fly across the transmission lines 104. The aerial vehicle 102 may record and/or communicate locations of the conditions 114 to be reported on, such as damage, and/or irregular frequencies (such as frequencies other than 60 hertz). When a frequency other than 60 Hz is detected one may infer that a condition 114 is occurring in proximity to the location of detection. Then, there may be any suitable indication to a remotely situated worker or computer 112A that the damage and/or irregularity is occurring, by way of example only, an alarm or messaging system may be triggered, and/or the screen on computer 112A may change colors and/or generate another notification. Once the condition is determined, the worker or lineman may be sent to fix the problem. Note that in countries other than the United States, other frequencies may replace 60 hertz, such as for example, 50 hertz. Further, any suitable frequency may be detected to indicate or create inference of the location of a condition 114.

All of the data recorded on one flight over a particular transmission line 104 may be collected and automatically compared to data recorded on another flight. For example, there may be a flight conducted after installation. The later flights could be compared to the flight after installation to determine any changes from the original installed system.

For purposes of obtaining optimal data sets, the proximity of the aerial vehicle 102 to the transmission line(s) 104 may be adjusted, the flight speed of the aerial vehicle 102 may be adjusted, and/or the specified range and accuracy of all sensor devices may be adjusted.

In another embodiment receiver 120 and booster transmitters may be mounted on pole supports 115 or towers 200 for transmitting signals to the aerial vehicle 102.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any inspection method including remote controlled ground vehicles.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An aerial inspection system, comprising:
a transmission line;
an aerial vehicle; and
a detection device coupled to the aerial vehicle, wherein the detection device is configured to detect a condition of the transmission line as the aerial vehicle flies across the transmission line.

2. The aerial inspection system according to claim 1, further comprising a controller configured to control the aerial vehicle remotely.

3. The aerial inspection system according to claim 1, further comprising a communication network for sending data about the aerial inspection system.

4. The aerial inspection system according to claim 1, wherein the aerial vehicle further comprises an unmanned airplane.

5. The aerial inspection system according to claim 4, wherein the unmanned airplane further comprises a drone.

6. The aerial inspection system according to claim 1, wherein the aerial vehicle further comprises a remote controlled helicopter.

7. The aerial inspection system according to claim 1, wherein the detection device further comprises a camera configured to capture data from the transmission line.

8. The aerial inspection system according to claim 1, wherein the detection device further comprises a receiver.

9. The aerial inspection system according to claim 8, wherein the receiver is configured for detecting at least one waveform transmitted by the transmission line.

10. The aerial inspection system according to claim 9, wherein the receiver is configured for detecting the waveform transmitted by the transmission line at about 60 hertz.

11. An aerial inspection system, comprising:
an electric transmission line;
a drone;
a controller configured to control the drone remotely;
a receiver coupled to the drone, wherein the receiver is configured to detect a condition of the electric transmission line as the drone flies across the electric transmission line; and
a communication network for sending data about the aerial inspection system.

12. The aerial inspection system according to claim 11, wherein the receiver is configured for detecting at least one waveform transmitted by the transmission line.

13. The aerial inspection system according to claim 12, wherein the receiver is configured for detecting the waveform transmitted by the transmission line at about 60 hertz.

14. A method of aerially inspecting a transmission line, comprising:
flying an aerial vehicle over a transmission line; and
detecting a condition on the transmission line with a detection device on the aerial vehicle.

15. The method according to claim 14, further comprising collecting data from the detection device.

16. The method according to claim 15, further comprising analyzing the data for determining whether there is any defect in the transmission line.

17. The method according to claim 16, wherein said step of flying the aerial vehicle over the transmission line comprises flying a drone over the transmission line.

18. The method according to claim 17, wherein said step of detecting a condition of the transmission line comprises detecting a waveform transmitted by the transmission line at about 60 hertz.

19. The method according to claim 18, further comprising the step of sending data, gathered by said step of detecting a condition, across a communication network.

20. The method according to claim 19, further comprising the step of controlling the drone remotely.
